(19) United States
(12) Patent Application Publication
(10) Pub. No.: US 2007/0136094 A1
(43) Pub. Date: Jun. 14, 2007

(54) System for entertaining children while in a healthcare environment

(76) Inventor: Julie Landmesser, Schererville, IN (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/604,037

(22) Filed: Nov. 20, 2006

Related U.S. Application Data
(60) Provisional application No. 60/738,505, filed on Nov. 21, 2005.

(51) Int. Cl. G06Q 10/00; B42D 15/00; G09B 23/28; G09B 25/00

(52) U.S. Cl. 705/2; 434/262; 434/365; 283/63.1

(57) ABSTRACT

An educational and marketing tool to be provided to children in healthcare settings such as, for example, physician offices, hospitals and outpatient facilities, is disclosed.

### CROSS-REFERENCE TO RELATED APPLICATIONS

This application claims the benefit of U.S. Provisional Application Ser. No. 60/738,505, filed on Nov. 21, 2005.

### FEDERALLY RESEARCH OR DEVELOPMENT

Not Applicable.

### TECHNICAL FIELD

The present invention relates to an educational tool to be provided to patients, such as children, in physician offices, hospitals and outpatient settings. The educational tool also acts as a vehicle for promoting a pharmaceutical or other product and/or service (e.g., medical devices) relating to the particular setting.

### BACKGROUND OF THE INVENTION

Currently about one-third of children are actively under the care of a physician. During each visit, a child and the parent/caregiver are typically faced with a long wait with little to do. There is a need for clinicians to adopt patient entertainment strategies similar to those long-employed by restaurants, such as crayons and coloring pages.

According to 1987 data reported in the American Journal of Public Health (vol. 87, No. 10, Oct 1987), at that time, less than ten percent of pharmaceutical expenditures were for children younger than 18. Today however, about one-third of children take medicines prescribed or recommended by physicians. There are over 200 medicines for children in development or waiting FDA approval today: forty-four target cancer, fourteen target cystic fibrosis, thirteen target asthma, twelve target AIDS and nine target epilepsy. The most common chronic condition among American youngsters is asthma, affecting an estimated five million children.

The pharmaceutical industry is now thriving in an interesting era. It is however, at the precipice of change from an old sales environment to a new restrictive environment, bringing a tremendous opportunity for original marketing ideas. Further many pharmaceutical companies are cutting back on sales representatives, thus increasing the need for high impact communications between representatives and physicians since fewer representatives will be seeing the physician on behalf of their company.

One of the most troubling changes for the pharmaceutical industry has been physicians' greatly reduced willingness to spend time with sales representatives. One result, Direct to Consumer Advertising (DTC) has a much bigger role in medicine than ever. Pharmaceutical companies continually attempt to uncover newer and more innovative methods to draw physicians' and patients' attention to their products. Unfortunately, many of the advertising specialties, premiums, and other methods are pervasive and losing impact.

Physician offices are seeing more patients with less time, which is increasing patient-wait times. Patients, particularly children, typically become impatient while waiting for clinicians due in part to physician offices spending fewer dollars on magazines, books, and traditional reading materials. Pharmaceutical companies, as well as other health-care related companies, such as, for example, medical device companies and health insurance companies, need more products and giveaways that create value for customers. Most current giveaways are utility oriented, such as pens, paper and the like, and are duplicated by many companies. Pharmaceutical sales representatives receive better access to treatment decision-makers when they bring items that enhance patient care. Pharmaceutical companies need products and giveaways that educate patients. Better educated patients are more willing to ask physicians for specific medications. Physicians will be spared many needless questions when patients are more informed, thus reducing physician/patient encounter times. Pharmaceutical companies want creative ways to advertise their products.

Accordingly, there is a need for an innovative product that merges patient education, relationship building and pharmaceutical marketing.

### SUMMARY

According to one aspect of the invention, a tool for educating pediatric patients and their parents as well as helping to advertise and market healthcare related products and services includes disease state and/or general health and wellness themed workbooks that include coloring pages and games. The workbooks may include puzzles, mazes, and/or quizzes. The workbooks may be sold to and/or produced by pharmaceutical companies, medical device companies, and/or health insurance companies, for distribution by their sales forces.

The invention facilitates an increase in health literacy, reduces waiting room boredom and encourages child/caregiver interaction, while providing healthcare related companies with a creative and practical DTC marketing method. The invention merges patient education, relationship building and pharmaceutical marketing.

### BRIEF DESCRIPTION OF THE DRAWINGS

FIG. 1 is a diagrammatic perspective view of a patent education tool.

### DETAILED DESCRIPTION OF A PREFERRED EMBODIMENT

While this invention is susceptible of embodiments in many different forms, there is shown in the drawings and will herein be described in detail, a preferred embodiment of the invention with the understanding that the present disclosure is to be considered as an exemplification of the principles of the invention and is not intended to limit the broad aspect of the invention to the embodiment illustrated.

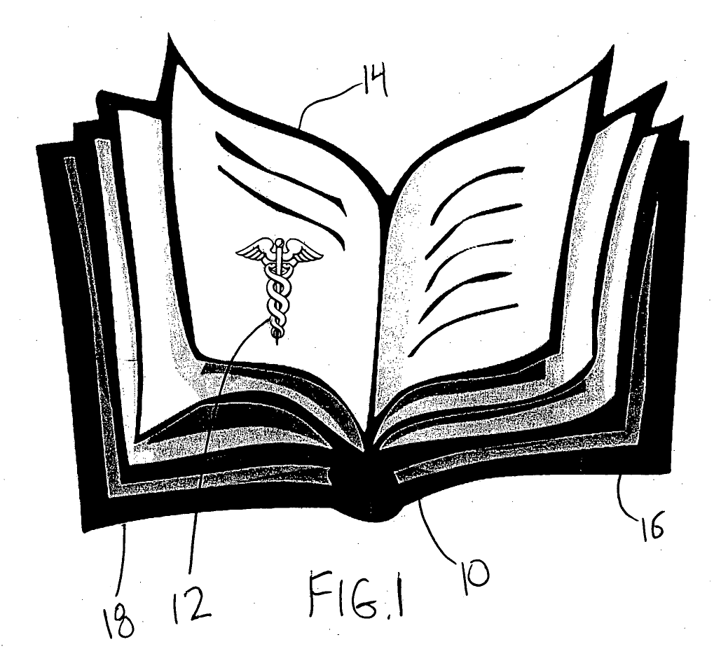

With reference to FIG. 1, the present invention is a tool that may be in the form of a book 10 which can incorporate marketing information, such as, for example, medication logos 12, into activity pages 14 and/or into a back cover 16 or front cover 18 of the book 10. The book 10 may be, for example, a coloring book or a workbook, and may be themed specifically to relate to one or more disease states, and/or may relate to general health and wellness (e.g., including general health and wellness tips).

This tool may be customized to specific disease states depending on the clinicians' specialty or products to be promoted by a pharmaceutical company. Patients would be exposed to relevant brands just before entry to patient rooms. Children represent an overlooked audience for basic health education. Children and their parents will benefit from educational activity books that inform them about important healthcare issues ranging from preventing the common cold, to recognizing signs and symptoms of an ear infection.

The tool will entertain and educate children and their parents/guardians, who are waiting in physician offices, about key health issues to improve their health and well-being while providing a medium for health-related companies' brand advertising.

The tool will advance the health and well-being of children through education in physician waiting rooms and exam rooms. The tool provides the healthcare industry, hospitals, and outpatient clinics with high-quality promotional products that are entertaining and educational for children. The tool will educate children and their parents/families on highly important healthcare issues in an exciting, child-friendly way through play and activity.

As discussed above, the situation in physician waiting rooms, emergency departments and outpatient clinics is characterized by long waits and limited educational products, toys or reading materials for children. As physician offices continue to seek ways to cut costs, budgets are becoming more restrictive with regard to spending dollars on patient-waiting room materials. Fully aware of this trend and the growing reliance on television to entertain children in physician offices, the tool permits hospitals, pharmaceutical companies and the like with a vehicle to market themselves to physician offices in a smarter way, with educational materials for the littlest of patients that support their office staff when the waits are long and children tend to lose their patience. The tool provides creative, child-friendly educational products that add value to pharmaceutical companies' clients and educates children on important healthcare issues facing them today and in the future.

While a specific embodiment has been illustrated and described, numerous modifications may come to mind without significantly departing from the spirit of the invention, and the scope of protection is only limited by the scope of the accompanying claims. For example, the invention may be applicable to adults as well as children by altering the content of the products according to the invention (e.g., by including sophisticated elements such as crossword puzzles, sudoku puzzles, etc.).

What is claimed is:

1. An educational and marketing tool comprising:
a book, wherein the book includes:
information relating to general health and wellness; and
marketing information relating to healthcare products and/or services.

2. The educational and marketing tool of claim 1, wherein the book is a workbook.

3. The educational and marketing tool of claim 1, wherein the book is a coloring book.

4. The education and marketing tool of claim 1, wherein the marketing information includes a trademark relating to the healthcare products and/or services.

5. A method of educating patients and caregivers while simultaneously advertising a healthcare related products and/or services, the method comprising:
producing books relating to general health and wellness and including marketing information relating to healthcare products and/or services; and
distributing the books to healthcare professionals for use in waiting rooms of the patient care facilities of the healthcare professionals.

6. The method of claim 5, wherein the book is a workbook.

7. The method of claim 5, wherein the book is a coloring book.

8. The method of claim 5, wherein the marketing information includes a trademark relating to the healthcare products and/or services.

9. An educational and marketing tool comprising:
a book, wherein the book includes:
information relating to at least one disease state; and
marketing information relating to products and/or services relating to the at least one disease state.

10. The educational and marketing tool of claim 9, wherein the book is a workbook.

11. The educational and marketing tool of claim 9, wherein the book is a coloring book.

12. The education and marketing tool of claim 9, wherein the marketing information includes a trademark relating to the products and/or services relating to the disease state.

13. A method of educating patients and caregivers while simultaneously advertising a healthcare related products and/or services, the method comprising:
producing books relating to at least one disease state and including marketing information relating to products and/or services relating to the at least one disease state; and
distributing the books to healthcare professionals for use in waiting rooms of the patient care facilities of the healthcare professionals.

14. The method of claim 13, wherein the book is a workbook.

15. The method of claim 13, wherein the book is a coloring book.

16. The method of claim 13, wherein the marketing information includes a trademark relating to the products and/or services relating to the disease state.
